(19) United States
(12) Patent Application Publication
(10) Pub. No.: US 2016/0317370 A1
(43) Pub. Date: Nov. 3, 2016

(54) CUSHION WITH BLADDERS RUNNING DIFFERENT PRESSURIZATION MODES INSIDE AND OUTSIDE DYNAMICALLY SELECTED TARGET BLADDER GROUP

(71) Applicant: 1834958 Alberta Inc., Calgary (CA)

(72) Inventors: David Richard Evans, Calgary (CA); Mary Lou Erik, Calgary (CA); Lyndon M. Lobo, Spruce Grove (CA)

(21) Appl. No.: 15/056,639

(22) Filed: Feb. 29, 2016

Related U.S. Application Data
(60) Provisional application No. 62/386,912, filed on Oct. 26, 2015.
(60) Provisional application No. 62/179,195, filed on May 1, 2015.

(51) Int. Cl. A61G 7/057; G05B 15/02; G05D 7/06; A47C 31/12

(52) U.S. Cl. CPC A61G 7/05776; A47C 31/12; G05B 15/02; G05D 7/06

(57) ABSTRACT

A responsive cushion system includes a pressure adjustment system and a cushion formed by an array of bladders coupled to the pressure adjustment system. At least two of the bladders are independent from one another such that that each can be independently pressurized and depressurized by the pressure adjustment system. A processor is coupled to the pressure adjustment system and a user interface, and the processor is operable to select a target group of one or more bladders according to data received via a communication interface. The processor is further operable to control the pressure adjustment system to adjust pressurization of bladders outside the target group according to a first pressurization mode, and control the pressure adjustment system to concurrently adjust pressurization of the target group of bladders according to a second, different pressurization mode. At least one of the first and second pressurization modes dynamically changes pressure over time.

### CROSS-REFERENCE TO RELATED APPLICATIONS

This application claims the benefit of U.S. Provisional Patent Application No. 62/386,912 filed Oct. 26, 2015 and U.S. Provisional Patent Application No. 62/179,195 filed May 1, 2015. Both of these applications are incorporated herein by reference.

### BACKGROUND OF THE INVENTION

(1) Field of the Invention

The invention pertains generally to cushions, chair overlays and mattresses suitable for long term patient seating and lying, and more particularly to a cushioning device utilizing a plurality of bladders independently pressurized according to different modes to help prevent and treat pressure sores.

(2) Description of the Related Art

The need for a proactive approach to skin ulcerations caused by constant pressure applied to a localized area of the body is rapidly increasing. Especially with the aging population caused by the baby boomer phenomenon, society has a need for effective and safe prolonged seating and lying options with reduced risk of bedsores. Almost all of us will at some point in our life be confined to a bed or chair as a result of illness, accident or disease.

Pressure ulcers, also known as bedsores and decubitus ulcers, most commonly develop in subjects who are immobile or are confined to wheelchairs or beds. Individuals who are critically ill or injured are very susceptible to decubitus ulcers because they may be unable to feel the problem developing and they are unable to make ongoing pressure relieving movements a non injured or non disabled individual person would who sits for extended periods of time. Continuous pressure exacerbated by moisture on the skin around the pressure point causes the skin to die and a sore to form.

Many of the presently available preventative and restorative measures relating to ulcerations have proven ineffective. Current technological solutions in the marketplace include air cushions which are custom made for each individual, and mattresses filled with static or alternating air pressure. A custom cushion can be tailored for the exact shape of a particular individual to ideally avoid all pressure points. However, cost of a custom cushion is high and people's bodies change shape over time requiring new cushions to be continually procured in order to maintain effectiveness. As another option, an external cover can be used in which a padding layer includes one or more air chambers suitable for being inflated for supporting a user's body. In some products, the pressure inside these air chambers is fixed; alternatively, the pressure is periodically alternated in adjacent air chambers. The goal of constantly changing pressure is to prevent a single pressure point from developing. Although alternating pressure is somewhat effective to prevent bedsores when used properly, there continues to be a rapid increase in the incidence of decubitus ulcers. Prevention is not fully effective, and treatment is problematic since it often involves nurses and other care providers repeatedly moving patients to different positions in order to both prevent new sores from forming and to facilitate healing of existing sores.

Resources which are spent treating pressure sores (PrUs) directly impact the funds available for other mainstream nursing activities. High value added nursing activities including many preventative activities could have funds directed towards them when the cost of treating pressure sores is substantially decreased. Additionally, if a patient is in a wheelchair because of an injury or disability, many would agree that financial resources would be better directed curing the patient's injury or disability, rather than treating the patient's pressure sores. Christopher Reeve, who played Superman (1978), died on October, 2004 of Sepsis, caused by an infected pressure ulcer following a horse ridding accident which left him as a quadriplegic on May 27, 1995.

### BRIEF SUMMARY OF THE INVENTION

According to an exemplary embodiment of the invention there is disclosed a responsive cushion system including a pressure adjustment system and a cushion formed by an array of bladders coupled to the pressure adjustment system. At least two of the bladders are independent from one another such that that each can be independently pressurized and depressurized by the pressure adjustment system. A processor is coupled to the pressure adjustment system and a user interface, and the processor is operable to select a target group of one or more bladders according to data received via a communication interface. The processor is further operable to control the pressure adjustment system to adjust pressurization of bladders outside the target group according to a first pressurization mode, and to control the pressure adjustment system to concurrently adjust pressurization of the target group of bladders according to a second pressurization mode. The second pressurization mode is different than the first pressurization mode, and at least one of the first and second pressurization modes involves the processor dynamically changing pressure over time.

According to another exemplary embodiment of the invention there is disclosed a cushion comprising of an array of bladders in a cushion and a pressure sensor array in a cushion. The cushion provides real-time proactive treatment and prevention of decubitus ulcers, more commonly known as bedsores and pressure sores, through the use of pressurization and depressurization of the array of bladders based upon sensor data received from the pressure sensor array. One-hundred bladders are in a ten-by-ten array and are controlled individually on a user interface which is connected to the cushion via a USB cord or other wiring configurations. The cushion is configured to operate in three modes, the first being a baseline mode where the pressure sensor array sends the processor real-time data about the areas of highest pressure, and then the processor automatically changes the pressure adjustment system such that the array of bladders and sensor array have equal pressure throughout. The second mode is a prevention mode which automatically rotates through three massage cycles. The third mode is an acute care or wound healing mode which is run with either automatically or manually targeted areas getting special treatment. The user picks one or more target area(s), or has the program automatically pick target area(s) based sensor array data for decubitus ulcer acute care and wound healing. Bladder pressure is automatically reduced by the processor within the target area(s) identified while the massage cycles of the prevention mode run at normal pressurization modes outside the target area(s). The system may also periodically perform the baseline mode outside the target area(s) to ensure no new pressure points are formed.

According to another exemplary embodiment of the invention there is disclosed a cushion comprising an array of bladders and a pressure sensor array where a bladder array such as one-hundred ten-by-ten bladders are configured into two-by-two zones for a total of twenty-five zones. The twenty-five zone are individually controlled on either or both of a user interface connected to the cushion via a USB cord, and a mobile app user interface which is connected to the cushion wirelessly.

According to another exemplary embodiment of the invention there is disclosed a cushion comprising an array of bladders and one or more sensor arrays adjacent the array of bladders. The sensor arrays may include pressure, temperature, RFID, and/or other sensor arrays and any combination thereof. Bladder zones are configured with thought toward where trouble areas will occur and/or the required resolution to target trouble areas. Areas of high risk for decubitus ulcers require a higher level of control and are therefor covered by a smaller zone size. For example, a group of two to four bladders may form a zone near the user's tailbone area. Areas of lower risk are covered by grouped bladders in larger numbers since these areas require less granularity of control. Likewise, greater number of sensors (e.g., pressure, temperature, etc.) are located throughout the areas of highest risk. For example, a temperature sensor array in the cushion is able to detect localized areas of increased temperature, which are correlated with a decubitus ulcer, and send a real-time signal to the processor indicating a target area of increased temperature. In turn, the processor can lower the pressure in the target area of increased temperature while simultaneously performing other dynamic massage cycles outside the target area in order to promote perfusion to the target area.

According to another exemplary embodiment of the invention there is disclosed a cushion in a shape of a cylinder. The cylindrical cushion contains a bladder array and optional sensor array(s) and is wrapped around a leg or arm and direct blood toward a wound, towards a diabetic's foot, or towards a user's heart, for instance.

Embodiments of the invention allow a user to select a decubitus ulcer or other target area(s) for prevention and acute case treatment, or allow a computer to select the target area(s) based on received sensor data.

Advantages of some embodiments include the prevention and reduction of occurrences of decubitus ulcers through the use of pressure sensing auto balancing, and massage cycles, particularly beneficial for individuals who have no feeling in their lower extremities, like diabetics, as well as paraplegics and quadriplegics, who remain in the same position for extended periods of time.

Advantages of some embodiments include selecting and changing of a targeting areas for different pressurization modes according to user input at a user interface. Manual selection of target areas is beneficial for individuals who know there is a trouble spot such as a wound or existing ulcer needing special attention.

Advantages of some embodiments include the use of sensor arrays enabling real-time, automatic selecting and changing of a targeting areas for different pressurization modes by one or more embedded processor(s). Automatic selection of target areas is beneficial for individuals who are unlikely to stay in the exact same position such as while moving during sleep or during activities.

Advantages of some embodiments include moving blood to a targeted area on a user's arm or leg, towards their foot, or towards their heart. Perfusion accelerates the wound healing process.

Advantages of some embodiments include decreasing the likelihood of a user falling out of their wheelchair.

These and other advantages and embodiments of the present invention will no doubt become apparent to those of ordinary skill in the art after reading the following detailed description of the preferred embodiment that is illustrated in the various figures and drawings.

### BRIEF DESCRIPTION OF THE DRAWINGS

The invention will be described in greater detail with reference to the accompanying drawings which represent preferred embodiments thereof.

FIG. 1 shows a block diagram of a responsive cushion system according to an exemplary embodiment of the invention.

FIG. 2 shows a top view of a ten-by-ten array of air bladders in the cushion of FIG. 1 according to an exemplary embodiment.

FIG. 3 shows a photo of a top view of a ten-by-ten array of bladders in the cushion of FIG. 1 according to an exemplary embodiment of the invention built as a prototype during development.

FIG. 4 shows top and side views of a sixteen-by-sixteen pressure sensor array in the cushion of FIG. 1 according to an exemplary embodiment.

FIG. 5 shows a side view of hardware for the cushion controller and cushion of FIG. 1 mounted on a wheelchair according to an exemplary embodiment.

FIG. 6 shows a pressure map with manual selection of target area displayed by either of the two the user interfaces while a user is sitting on the cushion of FIG. 1 according to an exemplary embodiment.

FIG. 7 shows a temperature map with automatic selection of target area hot spot displayed by either of the two the user interfaces while a user is sitting on the cushion of FIG. 1 according to an exemplary embodiment.

FIG. 8 shows a nine zone cushion with separate air intakes and outlets for each zone according to an exemplary embodiment.

FIG. 9 shows a flowchart of operations performed by the cushion controller of FIG. 1 according to an exemplary embodiment.

FIG. 10 shows examples of three different pressurization modules being different massage cycles according to an exemplary embodiment.

FIG. 11 shows the cushion of FIG. 1 being implemented in a cylinder shape according to an exemplary embodiment.

FIG. 12 shows a stacked configuration of the cushion of FIG. 1 according to an exemplary embodiment.

FIG. 13 shows a user interface with a target zone selected either manually by the user via one of the two user interfaces or automatically by the processor of FIG. 1.

### DETAILED DESCRIPTION

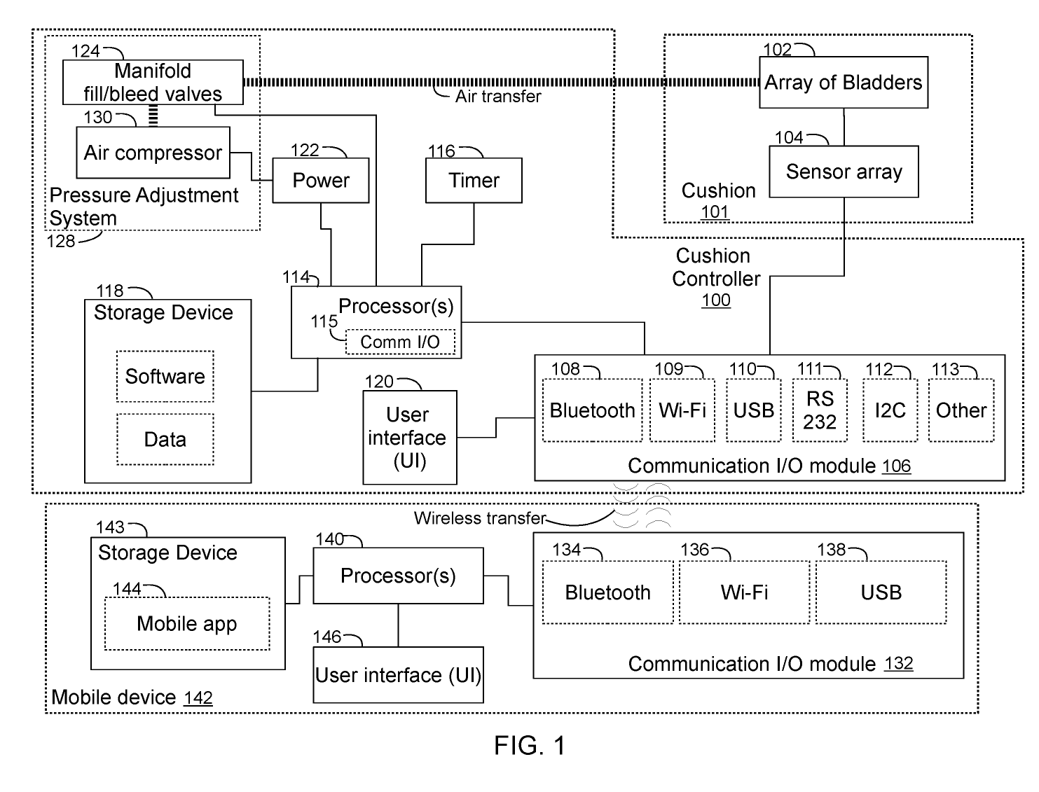

FIG. 1 shows a block diagram of a responsive cushion system according to an exemplary embodiment of the invention. The system includes a cushion controller 100 coupled to a cushion 101. The cushion 101 is made up of an array of bladders 102 coupled to a sensor array 104. The cushion controller 100 includes a communication I/O module 106 further comprising Bluetooth 108, Wi-Fi 109, USB 110, RS232 111, IC2 112, and/or other 113 communication interfaces. The cushion's communication I/O module 106 is coupled to one or more processor(s) 114, and the processor(s) 114 are coupled to a timer 116, a storage device 118, and a user interface (UI) 120. The processor(s) 114 are also coupled to a power supply 122 and manifold and fill/bleed valves 124. The valves 124 are part of a pressure adjustment system 128, which further includes an air compressor 130 also coupled to the power supply 122. As shown, the manifold and fill/bleed valves 124 are coupled via air tubing to the array of bladders 102.

The cushion's communication I/O module 106 acts as a communications hub for the processor(s) 114 and is coupled with one or more wired buses to the sensor array 104 in the cushion 101 and is coupled wirelessly to a communication I/O module 132 in a mobile device 142. In this embodiment, the processor(s) 114 further include an internal communications I/O module 115 allowing the processor(s) to directly control the manifold fill/bleed valves 124 and air compressor 130. In another configuration, these elements 124, 130 may also be coupled to the processor(s) 114 via the external communication I/O module 106. The fill/bleed valves 124 and the air compressor 130 may be activated and deactivated by solenoids through which current is controlled by switches (not shown) under control of the processor 114. As processor-based control of switches, air compressors, solenoids, and valves are well-understood, further details are omitted herein for brevity.

Similar to the cushion controller 100, the mobile device's communication I/O module 132 includes a Bluetooth interface 134, Wi-Fi interface 136, and a USB interface 138. The mobile device's communication I/O module 132 is coupled to one or more processor(s) 140 within the mobile device 142. The processor(s) 140 are further coupled to a storage device 143 storing a mobile app 144, and to a user interface (UI) 146.

In the following description, the singular form of the word “processor” will be utilized as it is common for an embedded CPU of a portable computing device to have a single processor (sometimes also referred to as a core); however, it is to be understood that multiple processors may also be configured to perform the described functionality for processor(s) 114 and/or processor(s) 140 in other implementations.

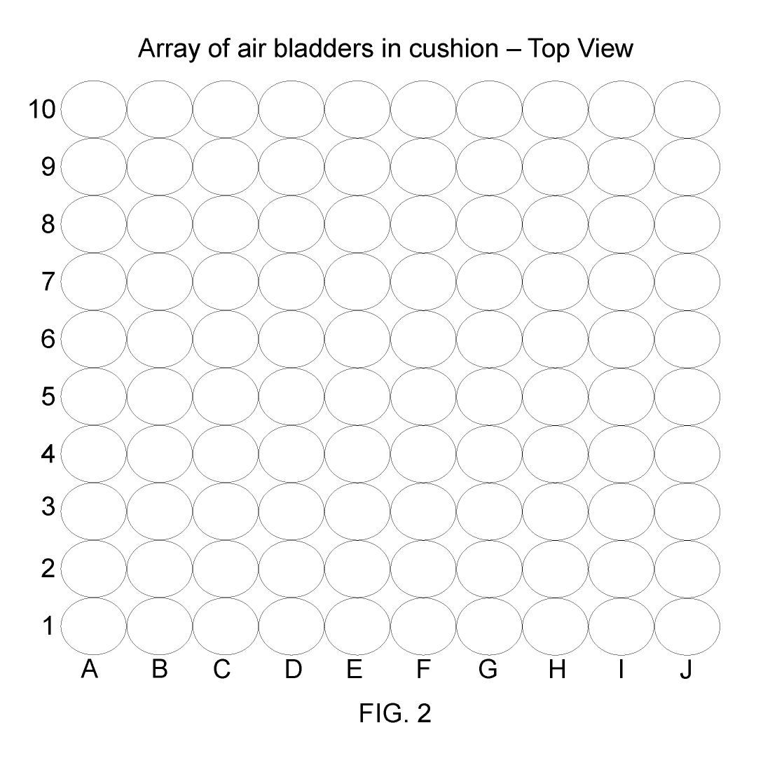

FIG. 2 shows a top view of a ten-by-ten array of air bladders in the cushion 101 according to an exemplary embodiment. The square shape of the cushion 101 in this embodiment may be utilized for a seat or wheelchair. For ease of identification, the bladders are labelled in FIG. 2 with rows 1-10 and columns A-J, and the coordinate system formed by these labels is utilized in this document when referring to a particular bladder. For example, a first bladder can be identified as the A1 bladder and a last bladder can be identified as the J10 bladder. The group of A1-J10 includes a total of one-hundred bladders (ten-by-ten).

The array of bladders 102 is inflated by the air compressor 130 and provides support to a user. By adjusting the manifold's fill/bleed valves 124, the processor 114 of the cushion controller 100 can independently inflate and deflate an individual or group of bladders. For example, by deflating a target group of bladders relative to other bladders, the cushion controller 100 reduces the pressure in and around the target bladders allowing a decubitus ulcer to have reduced pressure and enable healing.

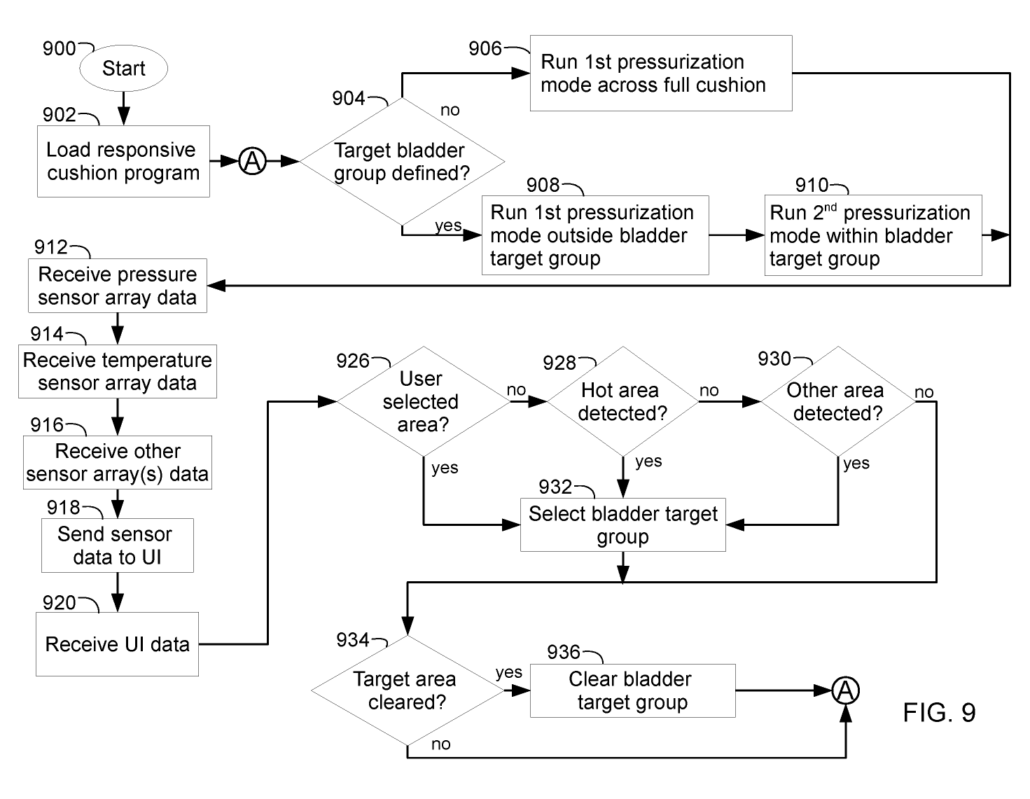

In the embodiment shown in FIG. 1, each of the cushion's air bladders is connected to the pressure adjustment system 128 via the manifold's fill/bleed valves 124 thereby enabling individual control of each of the one-hundred bladders by the processor 114. As will be explained further in the following, the bladders may be joined together to form zones of multiple connected bladders. For instance, another embodiment connects the bladders in two-by-two squares of four, such that there are a total of twenty-five total connections to twenty-five corresponding bladder zones that can be independently pressurized and depressurized by the processor 114. Other embodiments of the invention connect the bladders in custom shapes other than simple square groups according to application specific requirements. See FIG. 9 for a recommended embodiment targeting a wheelchair application with nine distinct bladder zones.

Besides providing support to a user, the bladder array 102 is controlled by the processor to inflate and deflate in different pressurisation modes, many of which include dynamically changing pressures thereby facilitating and promoting blood flow to trouble spots such as the ischial trochanters area, and to isolate several areas within the areas of high incidence and to provide positioning stability. With this in mind, even when all bladders are separate and independently inflatable, it is still possible for the processor 114 to select individual bladders or a group of bladders in various shapes to simultaneously and together run a particular pressurization mode. The zone shapes are not limited to squares or rectangles. For instance, L-shapes of bladders may be selected, or an O-shape of bladders. Other shapes, such as T-shapes, M-shapes or any other shape which the user may wish is possible. The ability to provide positioning and stability is highly customizable to the user and may depend upon the user's specific disability or injuring (user may have paraplegia, quadriplegia, or may only be temporality bound to a wheelchair) and the location existing decubitus ulcer(s). Likewise, different zones may be controlled by the processor 114 to run different pressurization modes at the same time. For instance, a first zone may be selected to run a first massage cycle while a second zone may be selected and simply deflated to prevent any pressure points occurring in the second zone.

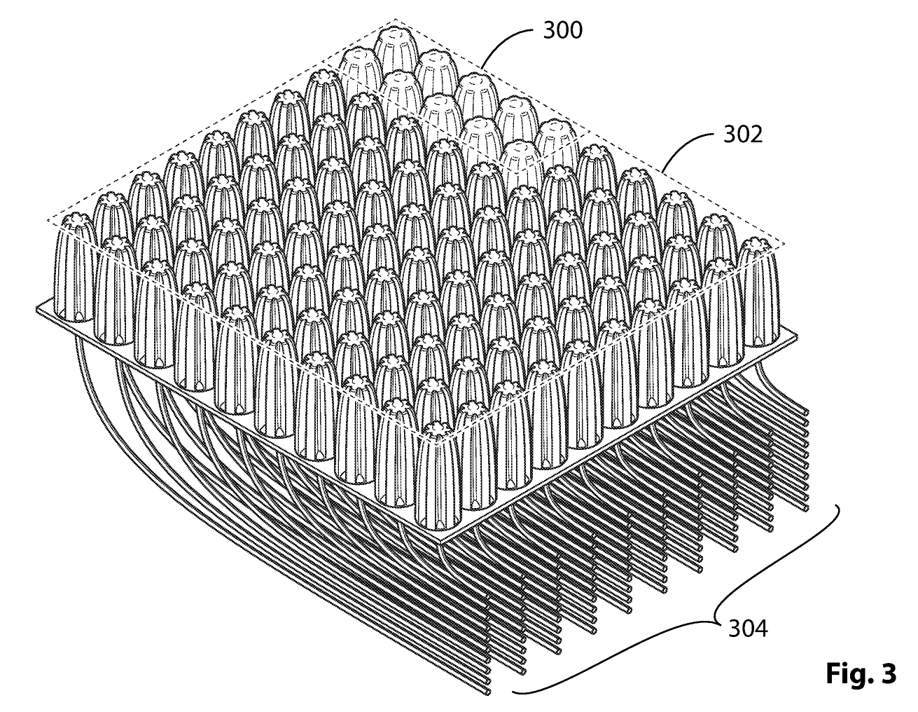

FIG. 3 shows an isometric projection view of a ten-by-ten array of bladders in a cushion array according to an exemplary embodiment. FIG. 3 shows a target group of two-by-five zone of inflated bladders 300 in the upper left corner in the inflated state. Ninety uninflated bladders 302 outside of the target group are also shown. The photo also shows tubing 304 used to each of the various air bladders to the manifold's fill/bleed valves 124 allowing the processor 114 to inflate and deflate desired bladders and/or zones of bladders. It is possible to inflate the inflated bladders 300 to a greater state than shown, and it is also possible to inflate the inflated bladders 300 to a state less than shown. All one-hundred bladders shown have the ability to quickly inflate and deflate to any desired level under control of the processor 114.

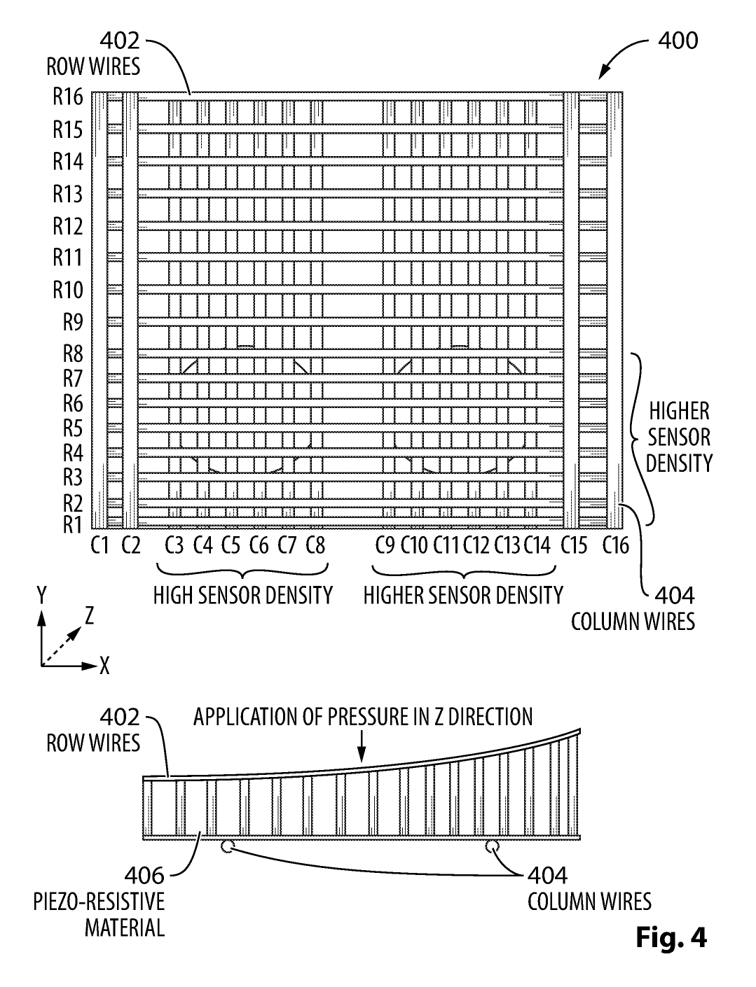

FIG. 4 shows top and side views of a sixteen-by-sixteen pressure sensor array 400 for use as the sensor array 104 in the cushion 101 according to an exemplary embodiment. Each of the sixteen conductive row lines 402 overlaps with sixteen conductive column lines 404. In total there are two-hundred and fifty-six points of intersection. Each point of intersection represents a separate pressure sensor providing data to the cushion processor 114. In this embodiment, the pressure sensor array 400 is implemented as a fabric pad positioned on top of the array of bladders in the cushion 101 and sits between the user and the array of bladders 102. Assuming again that the cushion 101 is a seat cushion on a wheelchair, the user sits on the pressure sensor array 400 and the array of bladders 102, both positioned inside a cushion bag. Other means such as sewed stitching or snaps may also be utilized to hold the cushion parts together and ensure that the sensor array 104 (e.g., pressure sensor array 400) stays orientated at the correct position on top of the array of bladders 102.

In some embodiments, the row and column conductive wires 402, 404 of the pressure sensor array 400 may be arranged in an equally-spaced grid pattern. However, rather than an equally-spaced grid, the pressure sensor array 400 grid in the embodiment shown in FIG. 4 is arranged such that it has the greater density in the areas of greatest risk of decubitus ulcers for the user. For instance, in the example shown the density is greater at the bottom right area (sensors intersecting columns C9-C14 with rows R1-R8) and the bottom left area (sensors intersecting columns C3-C8 with R1-R8) than in the other areas. These two areas of greater sensor density correspond with the ischial tuberosity on each side of the buttocks as the user is sitting on the cushion. Other layouts targeting other trouble areas or custom made for different shaped patients may be employed in other embodiments.

The two-hundred and fifty-six pressure sensors detect their individual pressure as sensor data representing current pressure values. The processor 114 may dynamically select target bladder group(s) and/or change the pressures in one or more bladder(s) or bladder zone(s) as the sensor data received via the communication interface changes over time. For example, a baseline prevention pressurization mode may involve the processor 114 determining when pressure values exceed a threshold value and then dynamically changing the air bladder pressure in that area to automatically remove pressure points. Likewise, if a user or the processor 114 has selected a specific target bladder group, the processor 114 may simultaneously run a second pressurization mode in the target group such as to fully deflate or inflate that target bladder group. Different pressurization modes run concurrently in different zones of the cushion 101 include dynamically changing pressure over time and keeping a static pressure. Both these two modes may be running but targeting different areas of the cushion such that a selected area remains static while pressure dynamically changes outside the area or vice versa.

Rather than or in addition to measuring pressure, other sensors can also be positioned in a grid layout similar to that of FIG. 4, for example, the intersection of the column lines C1-C16 with the row lines R1-R16 may include one or more of a pressure sensor, temperature sensor, RFID sensor, moister or any other type of sensor. The sensor data is sent to the cushion processor 114 via wires or wireless signals coupled either the external communication I/O module 106 or the internal communication I/O module 115. Similar to above, the processor 114 may dynamically select target bladder group(s) and/or change the pressures in one or more bladder(s) or bladder zone(s) in response to and as any of the different sensor data received via the communication interface changes over time. The cushion 101 is made up of a fabric designed to create a healing micro climate where the skin area is in contact with the cushion 101 surface.

In some embodiments, the pressure sensor array 400 is implemented by two outside layers of cloth or other fabric with embedded wires 402, 404 and separated by an inner layer of piezo-resistive material 406. The pressure sensor array 400 in this embodiment is made of three layers, where the outer sides of the fabric are made with conducive material fabric or wires 402 running along lines therein as shown by the lines in FIG. 4. As shown in the side view in FIG. 4, a conductive row wire 402 can be seen running along one outer side and conducive column wires 404 are seen running along the other outer side. An inner layer of the fabric is made of a piezo-electric material such as a piezo-resistive material 406 that changes resistance depending on pressure forces exerted thereon. When pressing down the selected woven elasticized fabric or piezo-resistive material 406 in the Z direction such as when a user sits on the cushion 101, the piezo-resistive material changes its electrical resistance characteristics. The actual pressure is detected by measuring voltage drop between a row wire 402 and a column wire 404, which depends on resistance of the piezo-electric material 406 changing with the physical deflection in the Z axis.

In operation, the processor 114 has a plurality of switches (not shown) to selectively connect any one of the row wire lines 402 to a voltage such as 5V. Each of the column wire lines 404 is electrically pulled to ground with a particular resistor value—i.e., sixteen resistors to ground having a same resistance are coupled to each of the column wire lines C1-C16. The processor 114 includes a number of general purpose input/output (GPIO) pins coupled to at least the column wire lines 404. In operation, the processor 114 receives pressure data from the pressure sensor array 400 as follows. The processor 114 first connects only the first wire row R1 to the voltage source. The processor 114 then cycles through each of the columns C1-C16 and reads and stores the voltage value detected at each column. An analog to digital converter (ADC) may be integrated with the GPIO pins within the processor 114, or an external ADC (not shown) may be utilized. The detected voltage values correspond to a voltage divider between the piezo-resistive material 406 and the pull down resistor on the column wire 404. Since the piezo-resistive material 406 in this embodiment decreases resistance as pressure increases, higher voltages read by the processor 114 on a particular column wire 404 mean that pressure is higher at the intersection point of the column wire 404 with the row wire 402 that is currently connected to power. The processor 114 cycles through connecting each row wire 402 to the voltage power source and, for each row, cycles through each column wire 404 reading the various voltages received in order to store the full pressure map of 256 points. The processor 114 may continually repeat the cycle, and resolution of the pressure sensor array 400 can be increased to any desired level by adding more wires rows 402 and/or wire columns 404. For example, a grid of two-hundred and fifty-six column wires 404 by two-hundred and fifty-six row wires 402 could be utilized in a more expensive cushion model to provide very high resolution pressure map.

Prefabricated and custom order pressure sensitive fabric is available on the market for a number purposes and can easily be adapted for use with the cushion 101. Examples of companies and products that provide fabric based pressure map sensor arrays 104 include Tekscan, Inc. Tekscan pressure mapping solutions, Vista Medical Ltd.'s BodiTrack™ Smart Fabric Sensors, and XSENSOR® Technology Corporation. As shown in FIG. 4, the pattern of the X-Y axis strips contained within the woven fabric is designed to provide more sensors in the areas with a higher incidence of decubitus ulcers. This design concentrates a higher density of sensors in high risk areas. Custom fabric sensor mats can be ordered according to these specifications. Other types of pressure maps can also be utilized including an array of discrete piezo-resistive sensors at each point of the grid rather than the film layer across the whole grid. When ordering custom pressure fabric solutions, measurement hardware and software may also be included by the manufacturer so that the controller processor 114 will not need to cycle through rows and columns and take analog to digital measurements. Instead, the controller processor 114 may simple receive a full pressure map from the sensor array 400 in the cushion 101 where the pressure values at all points is already available and updated at a device-specific refresh rate.

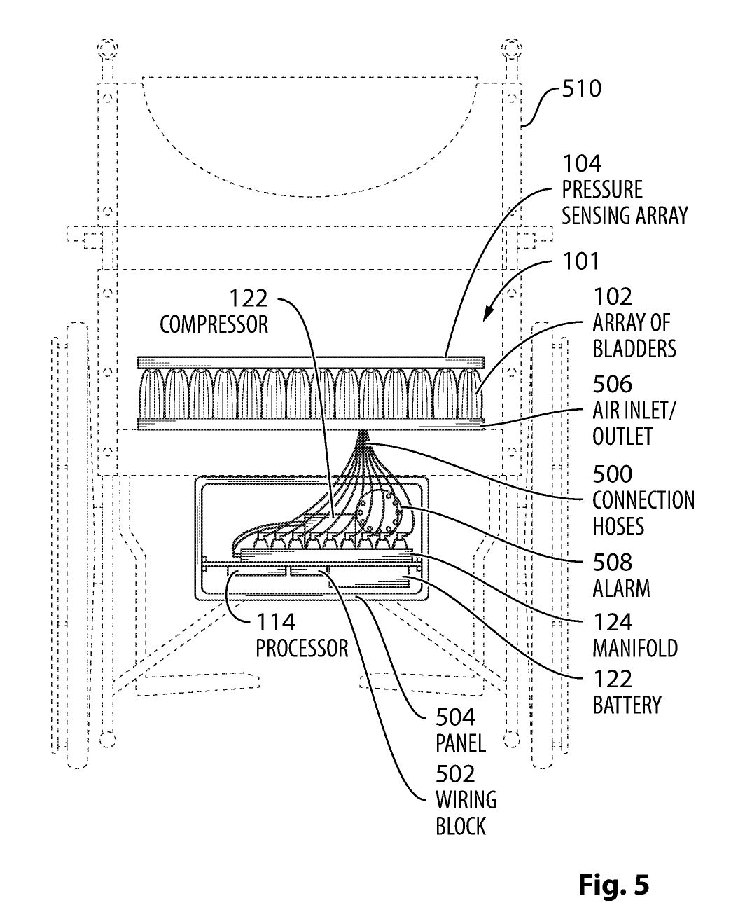

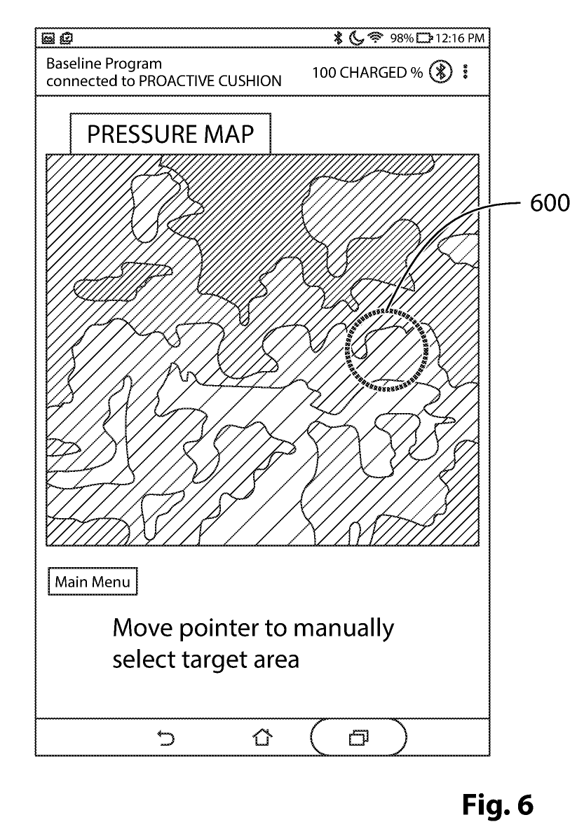

FIG. 5 shows a side view of hardware for the cushion controller 100 and cushion 101 mounted on a wheelchair 510 according to an exemplary embodiment. The source of power 122 is a 12 V 60 A DC battery, and the air compressor 130, the processor 114, the manifold and the fill/bleed valves 124 are valves located within a panel housing the controller mounted out of the way separately from the cushion 101. In a wheelchair application, the cushion controller 100 may be mounted in a panel either under the chair as shown in FIG. 6 or to the side or behind of the chair. In a bed application, the cushion controller 100 may be mounted in a panel on the back or side of the headboard with the cushion mounted across the length and width of the mattress, for example.

In this embodiment the cushion 101 comprises the pressure sensing array 104, the array of bladders 102 in a cushion 101, and an air inlet/outlet 506. The air inlet/outlet 506 is coupled to the manifold fill/bleed valves 124 by connection hoses 500. Mounted on a panel 504 the battery power 122 source powers the air compressor 130 to fill the array of bladders 102, as directed by the processor 122, providing air to the manifold and fill/bleed valves 124 via the wiring pin connection block 502. The manifold distributes the air to the bladder or bladder zones based upon the open or closed state of the fill valves, filling the bladder or bladder zone via a connection hose and the air inlet/outlet. The open or closed state of the fill valves is controlled by the processor 114 and the algorithm the processor 114 is running, and/or according to user input received by the processor 114.

To discharge a bladder or bladder zone within the array of bladders 102, the processor 114 directs a specific manifold valve 124 to actuate and change its state to a bleed position so that the bladder or bladder zone discharges its air to the atmosphere. In the bleed position the valve creates an open passage from the bladder(s) to the outside atmosphere. Air from the bladder or bladder zone travels in the opposite direction from the bladder or bladder zone through the air inlet/outlet, the connection hose, to the manifold, through the open bleed valves 124, and finally to the atmosphere.

In a similar manner, to inflate a bladder or group of bladders, the processor 114 directs a specific manifold blead fill valve 124 to actuate and change its state to a fill position so that the bladder or bladder zone receives air from the air compressor 130. In the fill position, the valve closes the connection to the atmosphere and instead connects the bladder(s) to the air compressor 130. Air from the air compressor 130 travels through the manifold fill/bleed valves 124 down the connection hose and fills the bladder(s) to the desired pressure.

The alarm horn 508 is operable to sound upon the compressor meeting a predetermined threshold for increased safety. As previously discussed, the pressure sensor array 130 sends real-time pressure data to the processor 114.

FIG. 6 shows a pressure map with manual selection of target area displayed by either of the two the user interfaces 120, 146 while a user is sitting on the cushion 101 according to an exemplary embodiment. The pressure map is displayed according to measurements by the pressure sensor array 400 under the user. The pressure map displayed on either UI 120, 146 may be updated in real time so that a user can immediately see as pressure points are developing. For instance, the map shown in FIG. 6 shows some higher pressure areas marked with less dense cross hashing around the area of the ischial tuberosity. In a baseline mode the processor 114 is configured to automatically deflate bladder(s) around those areas to remove those higher pressure points and prevent bedsores from forming at these points. Colors such as red may be utilized to indicate higher pressure areas and colors such as blue may be utilized to indicate lower pressure areas.

As there may be other trouble points such as a wounds or already formed bed sores that need special attention, in this embodiment the user may manually select one or more target area(s) to independently run different pressurization programs. The user selected target area(s) may have nothing to do with the areas or high pressure. For example, the user may know that there is already a bedsore or other wound occurring at a particular location and the user may select a target area according to that information.

The UI shown in FIG. 6 is in manual target area entry mode and the user has manually selected a target area 600. The processor 114 controls the pressure adjustment system 128 so that a target bladder group selected according to the target area 600 runs in a different pressurization mode compared with the bladders outside the target group 600. Examples of different pressurization mode options for the target bladder group selected according to the target area 600 include partly or fully deflated pressures that are held at a static, unchanging level. At the same point in time that the target bladder group selected according to the target area 600 is running a first pressurization mode such as statically holding at a deflated pressure, the group of bladders outside the target area 600 are controlled by the processor 114 to run in second pressurization modes such as massage cycles or baseline mode which automatically changes pressures to thereby prevent any pressure points from developing that exceed threshold pressure sensor values and thus promote perfusion within the target area.

Examples of pressurization modes that may be used both inside and outside the target area 600 include partly deflated, prevention, baseline, completely static, fully-deflate/threshold-inflate/cyclically-fully-deflate, and others not listed. The manually selected target area 600 of one or more bladders may correspond with a pain, a decubitus ulcer which has not registered on the sensors array 104, another type of wound, or a special area about which a doctor or other care provider is concerned. The user chooses a target area 600 on either of the two user interfaces 120, 146, and the program running on the processor 114 is operable to select a target area 600 of one or more bladders according to the user selection data received from the UI. The target area 600 of one or bladders is formed by one of more of the bladders shown in FIG. 2 and the bladders are found in the same position as the zone of interest selected by the user on either of the two user interfaces 120, 146. For example, the target area 600 of one or more bladders in this example corresponds to the four bladders H6, H7, I6, I7 shown in FIG. 2.

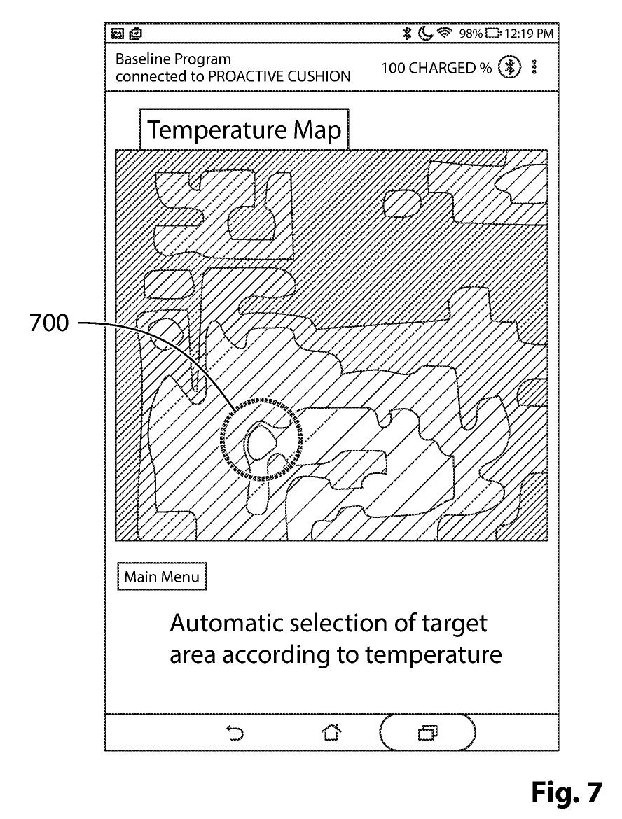

FIG. 7 shows a temperature map with automatic selection of target area hot spot 700 displayed by either of the two the user interfaces 120, 146 while a user is sitting on the cushion 101 according to an exemplary embodiment. In this example, areas with less dense cross hashing in FIG. 7 correspond to higher temperatures detected by the temperature sensor array.

The temperature sensor array is similar to the pressure sensor array 400 in many ways in that it relays real-time data to the processor 114 via the communications module 106, allowing the processor 114 to determine if the user has localized hot spot 700. Upon the detection of a hot spot 700 by the sensor array 104, the processor 114 is operable to automatically select a target group of one or more bladders according to data received via the communication I/O interface 106 indicating the position of the localized hot spot 700. The processor 114 controls the pressure adjustment system 128 adjusting the pressurization of bladders outside the target group for hot spot 700 according to a first pressurization mode and at the same time controls the pressure adjustment system 128 adjusting the pressurization of bladders within the target group of bladders at the hot spot 700 according to a second pressurization mode. The second pressurization mode may be different from the first pressurization mode. For example, the first mode running outside the hot spot 700 may be a massage cycle or baseline mode preventing pressure points from developing, while the second pressurization mode running inside the hot spot 700 may be a static low pressure mode paralleling the acute-care wounding healing mode. As the user changes position over time, the location of the detected hot spot 700 correspondingly moves with the user's movement and the processor dynamically selects a new target bladder group accordingly. While the hot spot 700 moves around in location, the processor 114 continues to control the pressurization mode of bladders within the target group at the new location of the hot spot 700 to be different than the pressurization mode of bladders outside the location of the hot spot 700.

Other types of sensor arrays may operate in a similar manner. For instance, an RFID sensor array may detect a trouble area by detecting an RFID chip enclosed in a bandage that a doctor places over a decubitus ulcer 702 or other wound. The processor 114 automatically selects a target bladder group according to the detected location of the RFID chip similar to as described above for the location of the hot spot 700. Other sensors and detection of trouble spot(s) may be done in a similar manner.

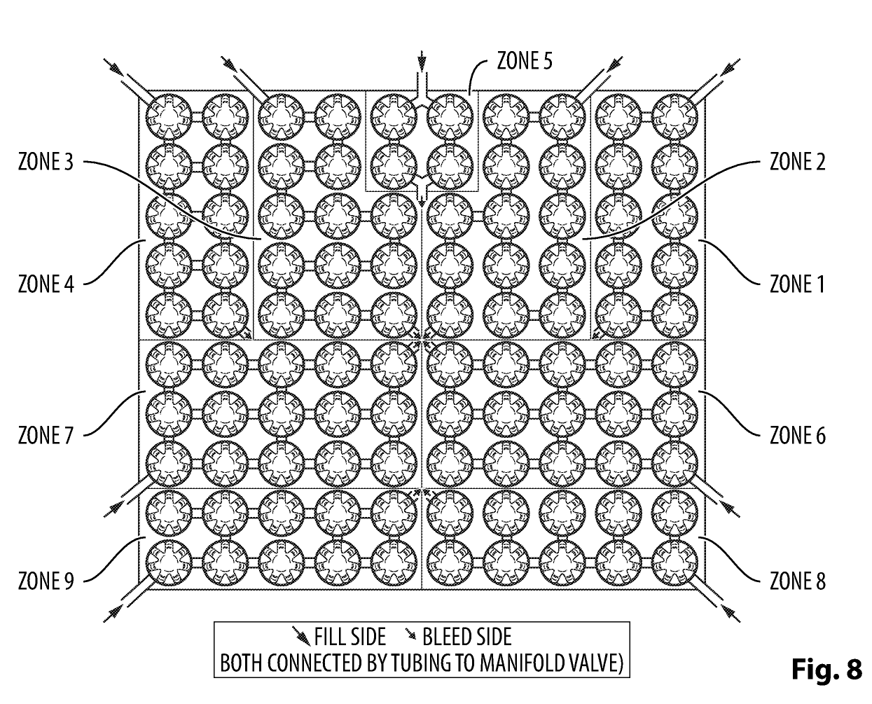

FIG. 8 shows a nine zone cushion 101 with separate air intakes and outlets for each zone according to an exemplary embodiment. For each zone, the locations of its connection hoses are shown, including the fill side and the bleed side. In this embodiment, the bladders within a particular zone are connected such that air flows from bladder to bladder within the zone and the zone as a whole is inflated or deflated. Since each zone is controlled individually in this configuration, the manifold only needs nine fill and bleed valves 124 within eighteen tubes in total thereby reducing the complexity while still allowing different bladder pressurizations at the same time. A target bladder group in this embodiment may be selected by selecting a particular zone of interest. For example, a user many manually select a particular zone as a target bladder group such as when there is an existing wound at a known location. Likewise, the processor 114 may automatically select a particular zone as a target bladder group such as when a temperature or other sensor array detects a trouble area.

In another example, users may select certain zones as target zone(s) for running in special pressurization modes for safety and stability. The layout of FIG. 8 is designed for a wheelchair application, and the user is intended to have their legs at the bottom of the figure, with the base of their spine at the top-middle of the figure, on or near zone five. Many decubitus ulcers occur near one's tailbone, thus zone five is designed to have a higher density of pressure sensors and the fewest bladders providing the greatest control resolution compared to other areas of the cushion 101. The user may select certain zones on the UI 120, 146 to manually set required pressure. For example, zones one and four can be pressurized (or depressurized) depending on the user's disability and their preference, providing lateral control for the user. Zones eight and nine can also be statically pressurized providing hamstring support, helping to prevent the user from falling forwards out of their wheelchair, adding a safety component to the user's cushion experience. Alternatively, zones eight and nine may be slightly deflated to ensure proper seating posture tilting the pelvis forward relieving pressure upon the coccyx and sacrum. If the user selects zones one and four as well as zones eight and nine to be statically pressurized such that their pressure does not change, the processor 114 will exclude these zones from massage cycles that run in the other zones. In general, any number of zones may be selected as one or more target bladder groups for different pressurization modes depending on application specific requirements.

For illustrative purposes, the zones are connected via a number of different structures in this example. Different connection structures cause different fill and bleed characteristics somewhat similar to a mini massage as bladders fill in a particular order according to the bladder connections.

In zone one its ten bladders are arranged in a two by five array with the intake fill side valve connected to the bladder in the upper right corner of the group. The bladders in the in this group are connected in parallel having only two connections each. The topmost two bladders closest to the intake fill side valve are connected, and the connection of the valves is such that the bladders connect in a vertical downwards direction, paralleling each other. The bottommost two bladders closest to the outlet bleed side valve are connected the outlet bleed valve being located in the lower left corner of the group. The three pairs of bladders which parallel one another (between the first pair of bladders connected to the inlet valve, and the last set of bladders connected to the outlet valve) are connected with one another.

In zone two, its thirteen bladders are arranged from right to left in three columns of five, five and three bladders, with the intake fill side valve connected to the bladder in the upper right corner of the group. The thirteen bladders of this group are connected in a snake-like pattern such that the bladders are connected in a vertical downwards direction for the first right column, then upwards for the second middle column, and downwards for the three bladders in the third left column. Each bladder has only two connections, with only one exception, the exception being where the bladders branch due to the fact that group two is not a rectangle, and must accommodate zone five at the corner of zone five. Accordingly, the branch-bladder has three connections. The branch-bladder is the eighth bladder of thirteen zone two bladders. Zone two terminates at its outlet bleed valve connected to the bladder located at the bottom left of the group which is also the center of the cushion.

In zone three its thirteen bladders match a mirror image pattern of zone two. The intake fill valve is connected to the top left bladder. The zone three bladders are connected in a snake like pattern, however the snake pattern is a zig-zag pattern, where every bladder has exactly two connections with no exceptions. Zone three terminates at its outlet bleed valve connected to the bladder located at bottom right of group three which is also the center of the cushion.

In zone four its ten bladders match a mirror image of zone one. The intake fill valve is connected to the top left bladder, and the outlet bleed valve is connected to the bottom right bladder. In zone four, each bladder is connected to its adjacent bladder, such that each and every bladder has three connections.

In zone five, its four bladders make up a two by two square with two bladders on top and two bladders on the bottom. The inlet valve is connected to the two bladders on top which are each individually connected to a bottom bladder. The two bottom bladders are each connected to the outlet bleed valve terminating zone five.

In zones six and seven are connected the same way, except that they are mirror images of the other. For simplicity and brevity, zone six will be disclosed. The fifteen bladders in in this group are arranged in a five by three array with its inlet fill valve connected to the bladder in the bottom righter corner of the group. The bottom right corner bladder is connected horizontally and vertically, similar to all corner bladders in zone six. The bladder in the center of zone six occupying position 3, 2 is connected to the four bladders which surround it. The four bladders which are located on the edge of zone six and in the middle have three connections. The remaining six bladders have two connections each. Zone six terminates at its outlet bleed valve connected to the bladder located at the top left of the group which is also the middle of the cushion.

In zone eight its ten bladders are arranged in a five by two array with the intake fill valve connected to the bladder in the lower right corner. Each of the lower row of bladders is connected to the bladder next to it and each is also connected to the bladder above it. Zone nine terminates at its outlet bleed valve connected to the bladder located at the top left of the group.

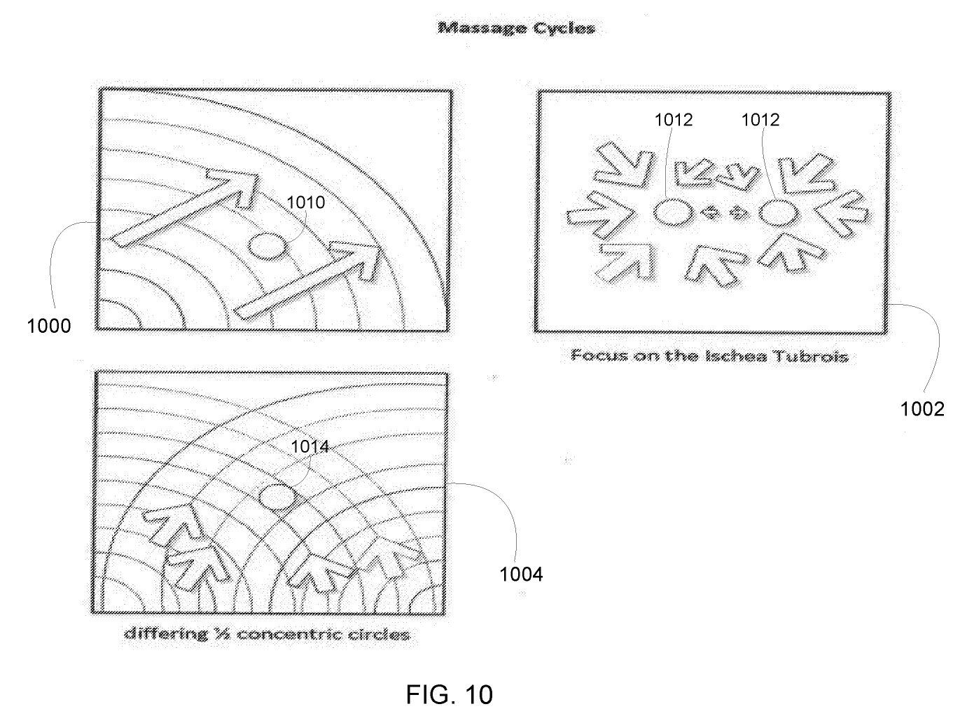

In zone nine its ten bladders are arranged in a five by two array with the intake fill valve connected to the bladder in the lower left corner. Each of the lower row of bladders is connected to the bladder next to it. Two bladders are connected to the row above it, being the second and fourth bladders. The first, third and fifth bladders in the top row are filled from the second and fourth bladders which are connected to the bottom row. Zone nine terminates at its outlet bleed valve connected to the fifth bladder in the top row located at the top right of the group. Disclosing eight different bladder connections between the intake fill side valve and the outlet bleed side valve for nine different bladder zones within this example show that it is possible to provide the user several different types of massages. Some examples of different massages that may be done either by bladder zone connections and/or by processor 114 control of fill and bleed are considered further below with reference to FIG. 10.

In other embodiments, each zone may be both inflated and deflated from a single tube. In other words, the fill side and bleed side may in fact by the same position in the zone, which further reduces the number of connection hoses to the same number of independently inflatable zones (e.g., nine in this example).

FIG. 9 shows a flowchart of operations performed by the cushion controller 100 according to an exemplary embodiment. The steps of the flowchart in FIG. 9 are not restricted to the exact order shown, and, in other embodiments, shown steps may be omitted or other intermediate steps added. In this embodiment, the one or more processor(s) 114 of the cushion controller 100 execute(s) control software stored in the storage device 118 in order to cause the cushion controller 100 to perform the illustrated steps.

The process begins at step 900 when the cushion controller 100 is turned on. The electronic components including the processor 114, storage device 118, and user interface (UI) 120 receive power 120. Additionally, the air compressor 130 within the pressure adjustment system 128 receives power 122.

At step 902 the processor 114 loads the cushion controller software program into memory. The cushion controller 100 boots up and begins execution of the software program. The processor 114 confirms the connection of the manifold and fill/bleed valves 124 are set to a default position of closed such that air is neither filled or emptied until further decision by the processor 114.

At step 904 the processor 114 evaluates if a target bladder group has been defined, either by the processor 114 or by the user. When no target bladder group has been defined by the processor 114 or the user, control passes to step 906; otherwise, when a bladder group is defined, control passes to step 908.

At step 906, since no target bladder group is currently defined, the processor 114 runs a first pressurization mode across the full cushion 101. Given that no bladder target group was defined at step 904, all bladders within the array of bladders 102 are controlled by the processor 114 with the same pressurization mode. Examples of pressurization modes that may be used include prevention modes such as massage cycles and pressure point elimination where the processor 114 automatically changes bladder pressures to alleviate pressure points detected by the pressure sensor array 104. Other pressurisation modes are also possible, including a completely static mode where the pressurization does not change with time, as well as a fully deflated mode which subsequently inflates to a threshold pressure and then cyclically deflates.

At steps 908 and 910, the processor 114 runs a first pressurization mode outside the bladder target group (step 908) while at the same time running a second, different pressurization mode within the bladder target group (step 910). Similar to as described in step 906, the pressurization modes that may be run include both dynamic and status pressures. In one application, outside of the bladder target group the processor 114 controls the pressure adjustment system 128 to run a dynamic pressurization mode that changes pressure over time. The pressure changes may be directly in response to time measured by the timer 116 such as a massage cycle or may also be in response to sensor data such as pressure points detected by the pressure sensor array 104. At the same time that the processor is running the dynamic pressurization mode outside the target bladder group, the processor 114 is also running a static pressurization mode inside the target bladder group. For example, the target bladder group may be completely deflated to allow better wound healing or may be completely inflated for better stability. Partial inflations/deflations may also be configured for other applications such as user comfort.

At step 912, the processor 114 receives pressure sensor array data via the communication I/O module 106.

At step 914, the processor 114 receives temperature sensor array data via the communication I/O module 106.

At step 916, the processor 114 receives other sensor array data via the communication I/O module 106 interface. Examples of other types of sensors that may be used include RFID, light, sound, moister, infrared, etc.

At step 918, the processor 114 sends sensor array data to either or both of the user interfaces (UIs) 120, 146 for display. A pressure map may be displayed as shown in FIG. 6 and/or or a temperature map may be displayed as shown in FIG. 7. If other sensors are included, it is possible to display other sensor maps, and different maps may also be overlaid with each other such as a combined pressure/temperature map. Other output of sensor data such as a list of values may also be presented instead of or in addition to graphical maps. The user reviews the displayed pressure, temperature, and/or other sensor array data to look for areas of high risk such as pressure points, which may turn into decubitus ulcers if not managed. The user may also interact with the UI 120, 146 in order to select one or more target area(s). For instance, see the UI screen of FIG. 6 where the user has selected a target area 600.

At step 920, the processor 114 receives UI data from one or both of the user interfaces (UIs) 120, 146. Examples of UI data that may be received include a user selected area or other commands to change pressurization modes, both in or outside of any target area(s) or target bladder groups.

At step 926, the processor 114 determines whether the user has selected a new target area according to data received from the UI 120, 146. As mentioned, the user may choose a target area based upon their knowledge and or pain. For instance, if the user has an decubitus ulcer which does not appear as a pressure point, or does not appear as a temperature variation, and is not detected by the other sensor arrays, the user at step 926 has the opportunity to select a target area manually—see user's manual selection of target area 600 in FIG. 6. When the user has selected a target area, control passes to step 932; otherwise, control continues to step 928.

At step 928, the processor 114 evaluates whether a new hot area has been detected by the temperature sensor array 104. A detected hot area may suggest an infection caused by a decubitus ulcer and the processor is operable to automatically detect this trouble area so that a different pressurization mode can be run within that area. For example, see the processor's 114 automatic selection of a target area hot spot 700 in FIG. 7. If no localized hot area is detected control is passed to step 930 however if control is passes to step 932.

At step 930, the processor 114 evaluates whether another new area of concern is detected by other sensor array(s) 104. If another area of concern is detected such as an area of increased moister by a moister sensor array, control is passed to step 932; alternatively, control passes to step 934.

At step 932, a target bladder target group is selected by the processor 114 according to a target area being either the user selected area at step 924, the hot area detected at step 926, or the other area detected at step 930. In some embodiments the processor 114 selects the target bladder group as the minimum group of air bladder(s) that cover the target area. For instance, when the user selects a small target area 600 as shown in FIG. 6, a single bladder such as bladder I6 in FIG. 2 may be sufficient to cover that area 600. Alternatively, the user may slightly enlarge the circle of the target area 600 and the processor 114 will select a group of four bladders such as H6, I6, H5, I5 in order to cover the larger target area. Likewise, for automatically detected hot spots 700 shown in FIG. 7, the processor may select a number of bladders and shape according to the size and shape of the hot spot 700. A large area of increased temperature may require a greater number of bladders to be selected as the target bladder group.

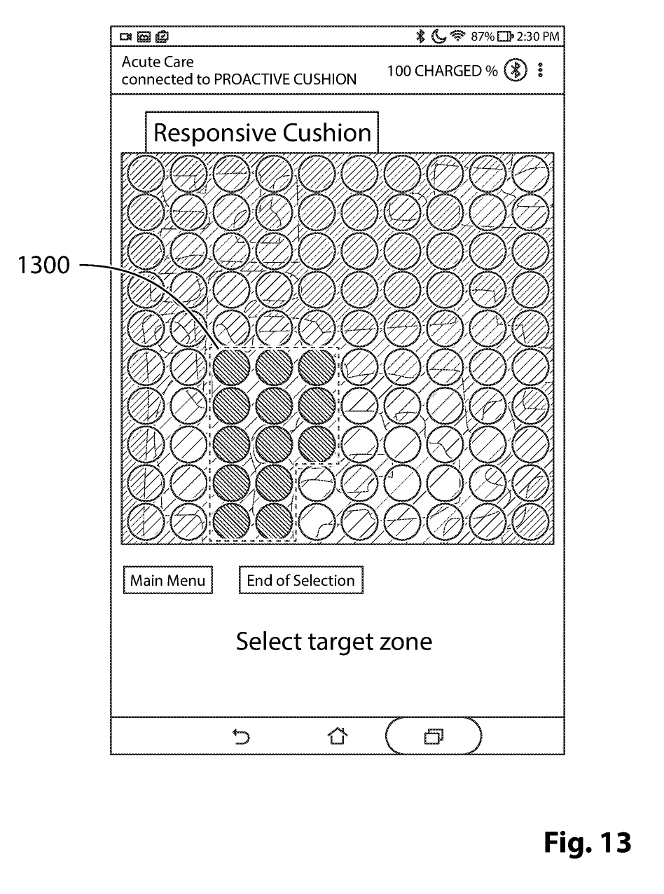

In yet another embodiment, bladder zones such as illustrated in FIG. 8 are used where a zones of bladders are pre-defined and fed by a common air hose. In this case, the processor 114 may select one or more of these zone(s) as the target bladder group according to the target area. For instance, if the user selected target area 600 or sensor detected hot spot 700 is within the sixth zone, the processor 114 will automatically select zone six as the target bladder group. FIG. 13 shows a user interface with a target zone 1300 selected either manually by the user via one of the two user interfaces 120, 146, or automatically by the processor 114.

At step 934, the processor 114 determines whether an existing target area has now been cleared. The user may choose to clear the bladder target group by clearing the target area 600 on FIG. 6. A clear button or other control (not shown) may be presented a different UI screen. Likewise, the processor 114 may also automatically determine to clear an existing target area according to updated sensor data. For instance, a hot spot may dissipate after a period of time and no longer require special pressurization mode. When an existing target area is to be cleared, control passes to step 936; alternatively, control returns via node A to step 904 to restart the above-described process.

At step 936, the processor 114 clears the existing target bladder group selected for clearing at step 934 and control returns via node A to step 904 where the above-described process is restarted. In one example, assume that prior to step 936 there was a single target bladder group selected according to a user selected targeted area 600 shown in FIG. 6. After executing step 936, there will no longer be a target bladder group defined. Therefore, upon a next iteration of the process at step 904, control will proceed along the “no” path to step 906 and the same pressurization mode will be run across the full cushion 101.

FIG. 10 shows examples of three different pressurization modules being different massage cycles according to an exemplary embodiment. The cushion 101 is able to change bladder or bladder zone pressure which can create a massage like effect for the user throughout the cushion 101. The massage motion may be done automatically by processor 114 and/or may also be facilitated by designing connection between air bladders within a zone in different ways such as shown in FIG. 8. Massage motions may be utilized to promote blood flow into blood deprived areas, and may replace the iconic backrub in hospitals and care facilities. Upon completion of the data analysis, instructions are sent to the cushion 101 controlling the bladder pressures. Soothing and therapeutic massage cycles on the cushion 101 with bladders or bladder zones facilitate decubitus ulcer prevention and healing.

Massage cycle 1000 shows a wavelike massage cycle pattern starting in the lower left corner broadcasting in an outwards direction towards the top right corner in concentric circles. Massage cycle 1000 is a light intensity massage cycle, with a general focus area. In the illustrated example, according to the acute care/wound healing mode, a center target area 1010 has been chosen by either the user or the processor 114 and a corresponding target bladder group is omitted from massage cycle 1000. The processor 114 runs a different pressurization mode such as a static deflation within the target bladder group corresponding to the center target area 1010.

Massage cycle 1002 is a medium intensity massage cycle with two wavelike patterns. The first pattern starts on the edge of the cushion 101 and broadcasts towards two foci 1012 where the user's ischial tuberosities have been detected to protrude onto the cushion 101 by the array of pressure sensors, as shown on FIG. 7. The second pattern starts between the ischial tuberosity protuberance's and broadcasts out towards them. In the illustrated example, according to the acute care/wound healing mode, the two foci 1012 where the user's Ischial tuberosity's have been detected have been chosen as target areas and two target bladder groups corresponding to the areas of these foci 1012 are omitted from massage cycle 1002. The processor 114 runs a different pressurization mode such as a static deflation within the target bladder groups corresponding to the foci 1012.

Massage cycle 1004 includes two wavelike patterns. The first pattern starts in the lower left corner broadcasting in an outwards direction towards the top right corner in concentric circles, and the second pattern starts in the lower right corner broadcasting in an outwards direction towards the top left corner in concentric circles. Massage cycle 1004 is a high intensity massage cycle with the two patterns focused on the middle-front and the center of the cushion 101. In the illustrated example, according to the acute care-wound healing mode, a center spot 1014 has been chosen as a target area and a target bladder group covering this area is omitted from massage cycle 1004. The processor 114 runs a different pressurization mode such as a static deflation within the target bladder group corresponding to the center spot 1014.

In addition to specific massage cycles, other dynamic pressurization modes of operation are also possible. For instance, dynamic pressurization modes may also include a baseline mode. In baseline mode, the processor 114 takes readings from all sensors every ninety seconds and adjusts bladders accordingly by sending commands from the processor to the pressure adjustment system and the manifold fill/bleed valves to control the pressure of the bladders or bladder zones. Baseline mode may also take an average reading over a range of time, e.g. five to ninety seconds. The purpose of baseline mode is to generally hold the pressure constant thereby providing stability to the user while also preventing high pressure areas for occurring. Baseline mode automatically results pressure points that develop being equilibrated. A user may watch a pressure map such as shown in FIG. 6 and see pressure points in red disappear in real-time.

Other modes include a prevention mode where the processor 114 rotates through each of the three massage cycles with thirty minutes on each massage. Between massages, three ninety second baseline cycles are run. At the end of the last massage the baseline mode is implemented for thirty minutes. If baseline mode runs for thirty consecutive minutes automatically initiates prevention mode.

In acute care/wound healing mode, the user selects an area on the map shown on smart device chooses length of time. A modified prevention mode is run where the target bladder group(s) corresponding to the user selected area(s) is/are de-pressurized and do(es) not participate in the massages that run. Each massage is divided equally into the time period selected instead of running for a full thirty minutes each. Three ninety second baseline cycles are run every thirty minutes if the time period exceeds thirty minutes. As previously described, acute care/wound healing mode may also be run in a similar manner with target bladder groups automatically selected by the processor 114 such as according to sensor array data.

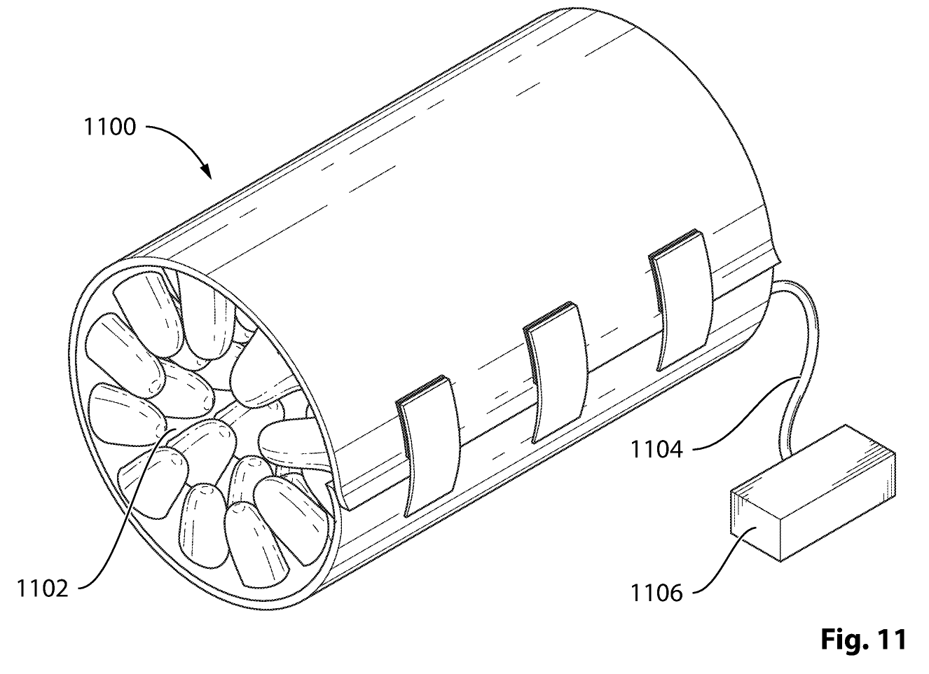

FIG. 11 shows the cushion 101 of FIG. 1 being implemented in a cylinder shape 1100 according to an exemplary embodiment. A purpose of rolling the cushion into a cylinder 1100 is to allow a user's arm, leg, or torso to be wrapped by the cushion 101. Wound healing and ulcer prevention may be facilitated by increasing the blood flow throughout the area enclosed by the cylinder 1100. Enhanced blood flow brings oxygen and nutrient-rich blood to the affected area—a requirement for the body to heal itself. Typically wounds caused by lack of blood circulation are the most problematic to treat. With diabetics the lack of healthy blood flow may lead to ulceration, consequently wound healing is also impaired. The absence of blood carrying oxygen is the primary cause of pressure ulcers and diabetic ulcers. The wound healing cylinder 1100 stimulates blood flow to a selected area.

Similar to as previously described, the caregiver may identify a primary target area on the mobile app user interface (UI) for special treatment with a different pressurization mode than the area outside the target area. Depending upon the treatment plan, a chosen massage or other pressurization mode promotes blood flow outside of the target area while a different pressurisation mode such as bladder deflation is used within the target area. The user chooses duration and intensity level of the massage on the mobile app user interface (UI). The cylinder shape may be in communication with a nursing station user interface allowing remote monitoring of the user's program selection, duration and safety by professional staff. Alarms and other fail safe mechanisms (including controls within the software and processor 114) may also sound to alert users and caregivers. Fail safe mechanisms may include normally-closed manifold fill valves 124 and normally-open manifold bleed valves 124.

The wound healing cylinder 1100 in this example employs many of the same components as the cushion 101 of FIG. 1, including the array of bladders 1102, the connection hose 1104, the cable connector 1106. Pressure, temperature, and/or or other sensor array(s) 104 may be included if desired. Additionally, the wound healing cylinder 1100 employ fasteners such as Velcro straps to hold it in the cylinder shape. Massage cycles may be employed by the processor 114 to move nutrient rich oxygenated blood to targeted zones, by incrementally increasing bladder pressure in a wavelike downward motion. This wavelike motion allows for the return of blood during the off cycle.

For the treatment of diabetic foot ulcers, the cylinder 1100 may be wrapped snuggly around the length of the leg. The array of bladders creates a downward motion increasing the blood flow to the affected area on the lower leg or foot. A similar smaller version of the same technology with temperature sensing capabilities affords a tight focus area enhancing blood flow and capillary action. Various stimulation massage cycles increase nutrient rich oxygenated blood flow to the targeted ulcerated area. Elevated temperate readings of the area determine the most beneficial area to enhance blood flow.

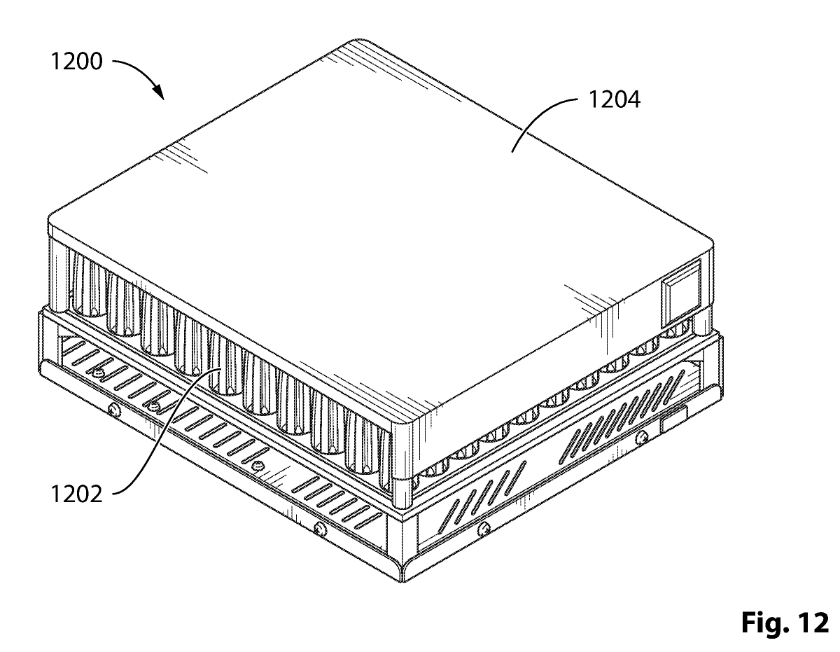

FIG. 12 shows a stacked configuration of the cushion 1200 including the array of bladders 1202 and the pressure sensor array 1204 where the power source 122, the storage device 118, the processor 114, the pressure adjustment system 128, the manifold and the fill/bleed valves 124 are located on the underside of the cushion 1200 beneath the array of bladders 1202 and the sensor array 1204. The local user interface (UI) 120 may be omitted with the stacked configuration or located at another location such as the arm rest of the wheelchair.

The user interacts with the cushion 1200 in one of two ways. The user connects the local user interface (UI) 120 using a wired USB 110 connection (not shown), or the user connects using a mobile app 144 using a wireless communication I/O module 132 to interact with cushion 1200 via the mobile app user interface (UI) 146. An advantage of the stacked configuration of FIG. 12 is that a user may easily move the device from one seat to another without requiring extensive installation or removal procedures. Similar to a booster seat, the stacked configuration be moved as needed such as for different users or for different seats such as wheelchairs, vehicles seats, reading chairs etc.

Although the invention has been described in connection with preferred embodiments, it should be understood that various modifications, additions and alterations may be made to the invention by one skilled in the art without departing from the spirit and scope of the invention. For example, although the above-description has focused on decubitus ulcers, other types of ulcer or skin aberration may be prevented and/or treated. Likewise, although an air compressor 130 is used within the above embodiments to fill the array of bladders 102 with air, any suitable gas or fluid could be used in place of air. Pumps and other types of compressors can be used as required. For instance, magneto rheological (MR) fluid with viscosity electrically controlled by the processor(s) 114 can be utilized in some embodiments rather than bladders with air pressure controlled via a compressor as described above. The power 122 can be either a DC battery or an AC power outlet. Although the types of sensors discussed above are pressure and temperature, other types of sensors can be used in other embodiments of the sensor array 104 including moisture sensors, force sensors, optical sensors, position sensors, magnetic sensors, acoustic sensors, proximity sensors, and any other type of sensor not listed herein. For example, an RFID or other position sensor array 104 in the cushion 101 is able to detect the presence of a RFID chip or other position indicator which has been placed adjacent to a decubitus ulcer or other wound or target area needing special care. Placing a position indicator adjacent to the decubitus ulcer may be done by embedding the position indicator within a bandage. Placing the position indicator adjacent to the decubitus ulcer can also be accomplished by stitching the position indicator into the user's clothing. Other methods of attaching a position indicator such as an RFID chip adjacent to the decubitus ulcer are also possible, and are not limited to those listed here. The position sensor array sends the signal to the processor 144 via the communication I/O module 106 indicating a current position of the position indicator so that the processor can automatically select and change a target group of bladders at that area accordingly. In yet another example modification, although the above description has focused on a single target group of bladders being selected, there may in fact be multiple target bladder groups all running different pressurization modes under control of the processor 114. Some target bladder groups may be selected according to user input received from the UI 115, 146 and some target bladder groups may be automatically selected by the processor 114 according sensor data received from one or more sensor arrays 104.

In some embodiments, the processor 114 is operable to turn on the compressor 130 and switch open a fill valve for a defined time period such as two seconds to fill a target bladder group, a specific bladder, or a bladder zone. The processor 114 is also operable open specific manifold bleed valves 124 for a defined time period such as two seconds to deflate a target bladder group, a specific bladder, or a bladder zone. In other embodiments, air pressure sensors are installed inside each bladder or bladder zone measuring the pressure within the bladder or zone. The processor receives this sensor data via the communication interface 115, 106 and controls the times that the valves and/or air compressors are opened in order to set a zone to a desired pressure according to the measured air pressure.

The bladder target groups, pressurization modes, and massage cycles, and cushion controlling software may be implemented by software executed by one or more processors 114, 140 operating pursuant to instructions stored on a tangible computer-readable medium such as a storage device to perform the above-described functions of any or all aspects of the access controller. Examples of the tangible computer-readable medium include optical media (e.g., CD-ROM, DVD discs), magnetic media (e.g., hard drives, diskettes), and other electronically readable media such as flash storage devices and memory devices (e.g., RAM, ROM). The computer-readable medium may be local to the computer executing the instructions, or may be remote to this computer such as when coupled to the computer via a computer network such as the Internet. The processor may be included in a general-purpose or specific-purpose computer that becomes the cushion controller 101, the mobile device 142, or any of the above-described modules as a result of executing the instructions.

In other exemplary embodiments, rather than being software modules executed by one or more processors, the modules may be implemented as hardware modules configured to perform the above-described functions. Examples of hardware modules include combinations of logic gates, integrated circuits, field programmable gate arrays, and application specific integrated circuits, and other analog and digital circuit designs.

Unless otherwise specified, features described may be implemented in hardware or software according to different design requirements. All combinations and permutations of the above described features and embodiments may be utilized in conjunction with the invention.

What is claimed is:

1. A responsive cushion system comprising:
a pressure adjustment system;
a cushion formed by an array of bladders coupled to the pressure adjustment system, wherein at least two of the bladders are independent from one another such that that each can be independently pressurized and depressurized by the pressure adjustment system; and
a processor coupled to the pressure adjustment system and a user interface;
wherein the processor is operable to:
select a target group of one or more bladders according to data received via a communication interface;
control the pressure adjustment system to adjust pressurization of bladders outside the target group according to a first pressurization mode; and
control the pressure adjustment system to concurrently adjust pressurization of the target group of bladders according to a second pressurization mode, the second pressurization mode being different than the first pressurization mode;
wherein at least one of the first and second pressurization modes involves the processor dynamically changing pressure over time.

2. The responsive cushion of claim 1, further comprising a sensor array positioned adjacent to the array of bladders and coupled to the communication interface, wherein the data corresponds to information detected by the sensor array.

3. The responsive cushion of claim 2, wherein the sensor array is a grid of temperature sensors and the data corresponds to temperature values at one or more positions on the grid.

4. The responsive cushion of claim 1, further comprising a user interface coupled to the communication interface; wherein the data represents input by the user at the user interface.

5. The responsive cushion of claim 4, wherein the user interface displays a map representing the array of bladders and allows the user to select an area on the map, and the processor selects the group of one or more bladders according to the selected area.

6. The responsive cushion of claim 4, further comprising a sensor array positioned adjacent to the array of bladders, the user interface displays a map showing values detected by the sensor array.

7. The responsive cushion of claim 6, wherein the sensor data represents current pressure values.

8. The responsive cushion of claim 6, wherein the sensor data represents current temperature values.

9. The responsive cushion of claim 1, wherein the processor changes the group of one or more bladders as the data received via the communication interface changes over time.

10. The responsive cushion of claim 9, further comprising a pressure sensor array wherein at least one of the first and second pressurization modes dynamically changes pressure according to pressure values received from the pressure sensor array meeting a threshold.

11. The responsive cushion of claim 10 wherein the pressure sensors are distributed such that an area of greatest interest is correlated with the greatest number of pressure sensors.

12. The responsive cushion of claim 1, further comprising a timer, wherein at least one of the first and second pressurization modes dynamically changes pressure according to a time duration.

13. The responsive cushion of claim 12, wherein both modes are dynamically changing in pressure.

14. The responsive cushion of 12, wherein at least one of the first and second modes involves a static pressure.

15. The responsive cushion of claim 1, wherein bladders are grouped into zones, each zone including predetermined bladder(s).

16. The responsive cushion of claim 1, wherein the processor is further operable to:
automatically select a plurality of groups of one of more bladders according to data received via the communication interface, and
control the pressure adjustment system to individually adjust pressurization of each of the group of bladders separately from other of the group of bladders.

17. A method for controlling pressurization of a cushion formed by an array of bladders coupled to a pressure adjustment system, wherein at least two of the bladders are independent from one another such that that each can be independently pressurized and depressurized by the pressure adjustment system, the method comprising:
selecting a target group of one or more bladders according to data received via a communication interface;
controlling the pressure adjustment system to adjust pressurization of bladders outside the target group according to a first pressurization mode; and
controlling the pressure adjustment system to concurrently adjust pressurization of the target group of bladders according to a second pressurization mode, the second pressurization mode being different than the first pressurization mode;
wherein at least one of the first and second pressurization modes involves the processor dynamically changing pressure over time.

18. The method of claim 17, wherein:
the cushion further comprising a sensor array positioned adjacent to the array of bladders and coupled to the communication interface; and
the data corresponds to information detected by the sensor array.

19. The method of claim 17, further comprising receiving the data from a user interface coupled to the communication interface, the data representing input by the user at the user interface.

20. A non-transitory computer-readable medium comprising computer executable instructions that when executed by a computer cause the computer to perform the method of claim 17.
